(19) United States
(12) Patent Application Publication
(10) Pub. No.: US 2003/0213281 A1
(43) Pub. Date: Nov. 20, 2003

(54) System and method for testing engine knock sensors

(76) Inventors: Pedro M. Corral, Juarez (MX); Efren Solis, CD. Juarez (MX); Juan C. Yanez, CD. Juarez (MX)

Correspondence Address: DELPHI TECHNOLOGIES, INC., Legal Staff, Mail Code: 480-414-420, P.O. Box 5052, Troy, MI, 48007-5052, US

(21) Appl. No.: 10/150,278

(22) Filed: May 17, 2002

(51) Int. Cl. G01N 3/62

(52) U.S. Cl. 73/1.01

(57) ABSTRACT

A system for testing knock sensors includes a test stand that includes a temperature chamber into which knock sensors to be tested are placed. A shaker is placed outside the chamber and includes a fixture that extends into the heating chamber. Thus, knock sensors can be heated or cooled to a predetermined temperature and then, shaken within the chamber.

### TECHNICAL FIELD

The present invention relates generally to engine knock sensors.

### BACKGROUND OF THE INVENTION

Most vehicles today are equipped with numerous sensors that are used to regulate the operation of the engine. One such sensor is an engine knock sensor. Typically, an engine knock sensor is mounted on an engine block, e.g., on the intake manifold or a cylinder head, and it produces an output voltage in proportion to the engine vibrations caused by uneven burning of fuel, a.k.a. knock. When knocking occurs, a microprocessor connected to the knock sensor can adjust the engine timing in order to minimize or eliminate the knocking.

To prevent failure of these knock sensors, they must be tested under simulated real life conditions prior to being installed in engines. One method for testing these sensors includes bringing the sensors to a desired temperature, i.e. heating or cooling them, and then manually transporting them to a test machine that is in an ambient temperature environment. Once the knock sensors are installed in the test machine, they are shaken in order to simulate an engine knock situation. Since the temperature of the knock sensors changes during the transport step, the testing can be unreliable and inaccurate. Moreover, since the transport step is performed manually, the entire test method is relatively slow, e.g., only two readings per sensor can be taken per hour.

Accordingly, the present invention recognizes that there is a need for a test system that brings the knock sensors to the desired temperature and then tests them within the same test stand.

### SUMMARY OF THE INVENTION

A knock sensor test system includes a test stand that has a temperature chamber therein. A shaker is placed external to the temperature chamber and includes a fixture that extends into the temperature chamber.

In a preferred embodiment, a knock sensor is mechanically coupled to the shaker via the fixture. Moreover, the test system includes a computer that controls the temperature within the chamber and the operation of the shaker. Preferably, a shaker table is placed beneath the temperature chamber and the shaker is placed on thereon.

In a preferred embodiment, the test system further includes a circulating fan within the test stand. Also, a liquid nitrogen pump is connected to the test stand and an air cooler is in fluid communication with the shaker.

In another aspect of the present invention, a knock sensor test system includes a test stand having a temperature chamber therein. In this aspect, the test system includes means for heating the temperature chamber and means for shaking a knock sensor placed within the temperature chamber.

In yet another aspect of the present invention, a method for testing an engine knock sensor includes installing a knock sensor in a test stand. The knock sensor is brought to a predetermined temperature and heating/cooling means within the test stand are shut down. Then, the knock sensor is shaken within the test stand.

In still another aspect of the present invention, a method is provided for testing a sensor that is engaged with a test stand that has a cooling system, an air circulating system, and a heating system. The method includes periodically interrupting one or more of the systems. Then, a sensor performance test is conducted.

In yet still another aspect of the present invention, a method is provided for testing a sensor that is engaged with a test stand that has cooling means, air circulating means, and heating means. The method includes periodically interrupting one or more of the means. Then, a sensor performance test is conducted.

The present invention will now be described, by way of example, with reference to the accompanying drawings, in which:

### BRIEF DESCRIPTION OF THE DRAWINGS

FIG. 1 is a diagram of a knock sensor test system; and

FIG. 2 is a flow chart of the method for testing knock sensors.

### DESCRIPTION OF AN EMBODIMENT OF THE INVENTION

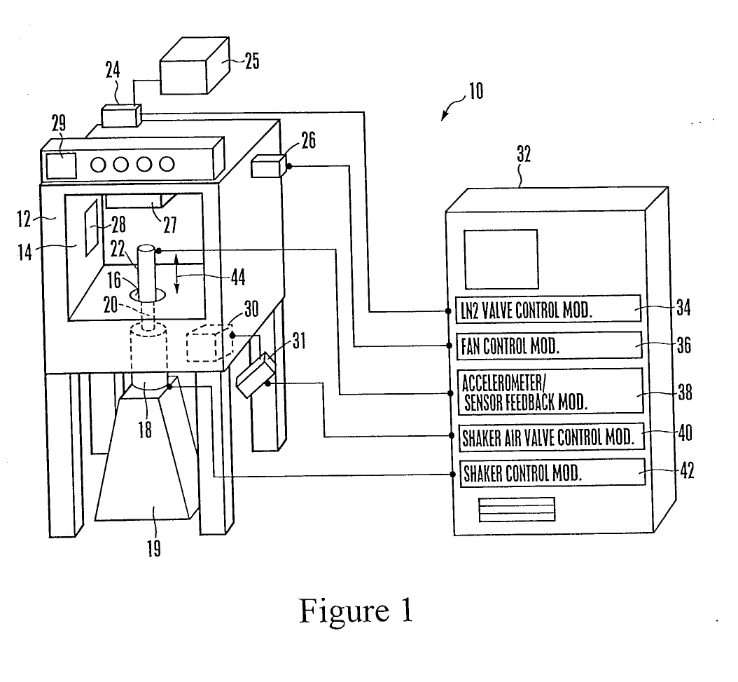

Referring initially to FIG. 1, a knock sensor test system is shown and generally designated 10. FIG. 1 shows that the test system 10 includes a test stand 12 having a temperature chamber 14. The test stand 12 is formed with a bore 16 that leads from beneath the test stand 12 into the temperature chamber 14. A shaker 18, e.g., one manufactured by Brüel and Kjaer, is placed beneath the temperature chamber 14 on a shaker table 19. It is to be understood that the shaker 18, which is typically rated to operate properly at temperatures from five degrees Celsius to forty degrees Celsius (5° C.-40° C.), preferably is isolated from the temperature chamber 14 which can experience temperatures from negative forty degrees Celsius to one hundred and forty degrees Celsius (−40° C.-140° C.). Thus, the preferred shaker 18 includes a fixture 20 that extends from the shaker 18 through the bore 16 into the temperature chamber 14 to prevent direct contact between the shaker 18 and the temperature chamber 14.

During testing, described below, a knock sensor 22 is mechanically coupled to the shaker 18 via the fixture 20. Further, the fixture 20 and the shaker table 19 must have particular mechanical properties, e.g., stiffness, damping and weight, so that they will not resonate within the range of testing for the sensor 22, e.g., zero to eighteen kilohertz (0-18 KHz).

As further shown in FIG. 1, the test stand 12 includes a liquid nitrogen valve relay 24 that can be opened and closed to control the flow of liquid nitrogen from a liquid nitrogen pump 25 to the test stand 12 and, thus, reduce the temperature of the test stand 12 and, hence, the knock sensor 22. Also, the test stand 12 includes an internal fan relay 26 that can be turned on and off to control a circulating fan 27 within the temperature chamber 14. A heating element 28 is installed within the temperature chamber 14 and is controlled by a thermostat 29. The heating element 28 can be used to increase the temperature of the test stand 12 and the knock sensor 22 installed within.

It is to be understood that the shaker 18 includes an air cooler 30 that cools the shaker 18 to prevent it from being damaged by high temperatures within the temperature chamber 14. As shown in FIG. 1, the test stand 12 includes a shaker air valve relay 31 that is used to shut off or turn on the flow of air through the air cooler 30.

FIG. 1 shows that the test system 10 further includes a computer 32. The computer can include multiple control modules to control the operation of the test stand 12. For example, the computer 32 includes a liquid nitrogen valve control module 34 that operates the liquid nitrogen valve relay 24. Also, the computer 32 can include a fan control module 36 that controls the internal fan relay 26. FIG. 1 shows that the computer 32 can also include a sensor feedback module 38 that receives feedback from the knock sensor 22 during testing, described below. As shown in FIG. 1, the computer 32 can include a shaker air valve control module 40 that controls the shaker air valve relay 31 to cool the shaker 18 when necessary. The computer 32 can also include a shaker control module 42 that controls the operation of the shaker 18 during testing. It is to be understood that the shaker 18 shakes the knock sensor 22 in a vertical direction as indicated by axis 44.

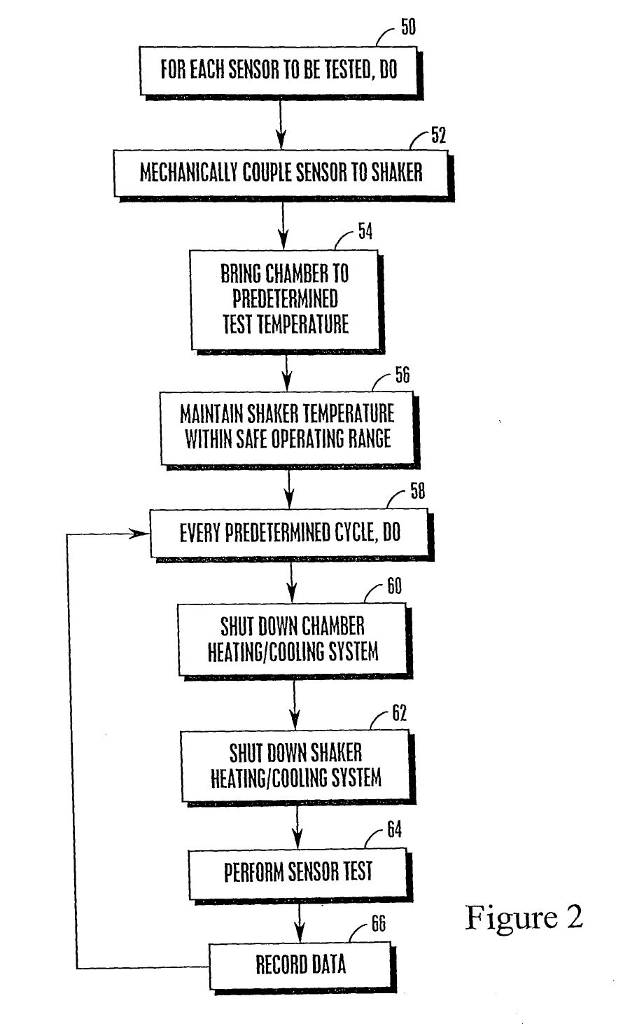

Referring now to FIG. 2, the test logic of the present invention is shown and commences at block 50 with a do loop wherein for each sensor to be tested the succeeding steps are performed. At block 52, the sensor 22 is mechanically coupled to the shaker 18 via the fixture 20. Thereafter, at block 54, the chamber 14 is brought to a predetermined test temperature, e.g. negative forty degrees Celsius to one hundred forty degrees Celsius (−40° C.-140° C.). Moving to block 56, the shaker temperature is maintained within a safe operating range, e.g., five degrees Celsius to forty degrees Celsius (5° C.-40° C.).

Continuing to block 58, an internal do loop is entered wherein for each predetermined cycle, e.g., twenty-five to thirty seconds, the following steps are performed. At block 60, the chamber heating/cooling system is shut down. Next, the shaker heating/cooling system is shut down at block 62. Proceeding to block 64, the knock sensor 22 is tested, i.e., the shaker 18 is actuated at a predetermined frequency and amplitude in order to simulate an engine knock condition and an analog signal is generated in response thereto. Then, at block 66, the test data is recorded. It is to be understood that the test system 10 only tests the knock sensor 22 when the test stand 12 is stable, i.e., without any noise sources such as that caused by liquid nitrogen input to the test stand 12, internal fan noise, and shaker cooling system noise. The logic then returns to block 58 and steps 58 through 66 are repeated a predetermined number of times to get a sufficient quantity of test data for the knock sensor 22.

It is to be understood that during thermal cycle time the thermostat 28 maintains a constant chamber temperature and then is interrupted for six to eight seconds (6-8 sec.) in order to test the knock sensor. These interruptions do not significantly affect the temperature within the chamber 14 and a tolerance of plus or minus five degrees Celsius (±5° C.) is achieved during the test.

With the configuration of structure and method described above, the test system 10 can relatively quickly and accurately test knock sensors without manually transporting the knock sensors after they are heated. Thus, a substantial amount of time in the testing process is reduced. Also, a series of tests for a particular knock sensor can be relatively easily performed for a range of temperatures.

While the particular SYSTEM AND METHOD FOR TESTING ENGINE KNOCK SENSORS as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A knock sensor test system, comprising:
a test stand;
a temperature chamber within the test stand;
a shaker placed external to the temperature chamber; and
a fixture attached to the shaker, the fixture extending into the temperature chamber.

2. The test system of claim 1, further comprising:
at least one knock sensor mechanically coupled to the shaker via the fixture.

3. The test system of claim 2, further comprising:
a computer electrically connected to the test stand, the computer controlling the temperature within the chamber and the operation of the shaker.

4. The test system of claim 3, further comprising:
a shaker table placed beneath the temperature chamber, the shaker being placed on the shaker table.

5. The test system of claim 4, further comprising:
a circulating fan within the test stand.

6. The test system of claim 5, further comprising:
a liquid nitrogen pump connected to the test stand.

7. The test system of claim 6, further comprising:
an air cooler in fluid communication with the shaker.

8. An knock sensor test system, comprising:
at least one test stand;
at least one temperature chamber within the test stand;
means for heating the temperature chamber; and
means for shaking a knock sensor placed within the temperature chamber.

9. The test system of claim 8, further comprising:
means for cooling the temperature chamber.

10. The test system of claim 9, further comprising:
means for cooling the shaker.

11. A method for testing an engine knock sensor, comprising the acts of:
installing a knock sensor in a test stand;
bringing the knock sensor to a predetermined temperature;
shutting down heating/cooling means within the test stand; and
shaking the knock sensor in the test stand.

12. The method of claim 11, further comprising the act of:
receiving an analog signal from the knock sensor.

13. The method of claim 12, further comprising the act of:
cooling a shaker placed adjacent to the test stand with a shaker cooling means.

14. The method of claim 13, further comprising the act of:
shutting down the shaker cooling means.

15. The method of claim 14, further comprising the act of:
shaking the knock sensor in the test stand.

16. In a test stand having at least one of: a cooling system, an air circulating system, and a heating system, a method for testing a sensor engaged with the test stand, comprising:
periodically interrupting at least one of the systems; and
conducting at least one sensor performance test during interruption.

17. The test stand of claim 16, wherein the sensor is a vehicle knock sensor.

18. The test stand of claim 17, wherein the test stand further includes a shaker that can vibrate the knock sensor.

19. In a test stand having at least one of: cooling means, air circulating means, and heating means, a method for testing a sensor engaged with the test stand, comprising:
periodically interrupting at least one of the means; and
conducting at least one sensor performance test during interruption.

20. The test stand of claim 19, wherein the sensor is a vehicle knock sensor.

21. The test stand of claim 17, wherein the test stand further includes shaker means to vibrate the knock sensor.
